(19) United States
(12) Patent Application Publication
(10) Pub. No.: US 2018/0182268 A1
(43) Pub. Date: Jun. 28, 2018

(54) VISUAL MESSAGE TRANSMISSION DEVICE

(71) Applicant: Derick ARIPPOL, São Paulo (BR)

(72) Inventor: Derick ARIPPOL, São Paulo (BR)

(21) Appl. No.: 15/547,806

(22) PCT Filed: Jan. 22, 2016
(86) PCT No.: PCT/BR2016/050006

§ 371 Date: Aug. 1, 2017

(30) Foreign Application Priority Data
Sep. 18, 2015 (BR) BR1020150240864

(51) Int. Cl. G09F 13/20; B44F 1/06; B44C 1/17; F21V 9/32; G09F 7/18; C09J 7/24

(52) U.S. Cl. CPC G09F 13/20; B44F 1/06; C09J 7/243; F21V 9/32; G09F 7/18; B44C 1/1741

(57) ABSTRACT

The present abstract relates to a patent of invention for a visual message transmission device (1), pertaining to the field of application of the phenomenon of phosphorescence and to the field of self-adhesive articles, and it was designed in order to display messages such as promotional or ludic or decorative or technical ones or information signs, in the shape of the silhouette of any objects and/or texts; such device comprises: a light source (10), a transparent surface (20) traversed by light (11) generated by the light source (10), and by a layer (30) of phosphorescent and light-permeable pigment, applied to the transparent layer (20) that, when the light source (10) is on, is activated and traversed by the light (11) generated by the source, and when the light source (10) is off, the layer (30) emits phosphorescent light (12); such device having its preferential construction comprised of the phosphorescent layer (30) and for self-adhesive transparent article (40) on which the layer (30) is printed on and that is adhered to the transparent layer (20).

This specification relates to a patent of invention for visual message transmission device, belonging, in a wider sense, to the field of application of the phenomenon of phosphorescence, and, in a more specific application, to the field of self-adhesive articles, and it was designed to transmit visual messages of promotional or ludic or decorative or technical types, among others.

### STATE OF THE ART

A wide variety of products that make use of the phenomenon of phosphorescence is already known, such as switch plates, sockets and other electric devices, face of clocks or watches, pacifiers, toys, panel buttons in vehicles and light-signalling devices, among others. These articles or the material from which they are made have photo-luminescent chemical structure, which is activated when there is light; when this happens, the surface of said articles maintains non-phosphorescent visual and, when there is no light, such structures emit light, causing the surface of the articles to be phosphorescent, according to knowledge that has already been absorbed by the state of the art. The present patent aims at a new application of this phenomenon, which is particularly employed to the field of self-adhesive articles.

### OBJECTIVES OF THE INVENTION

Thus, the objective of the present patent is to provide a message transmission or vehicle for communication device which makes use of the phenomenon of phosphorescence.

Another objective is to provide visual message transmission device that makes use of the phenomenon of phosphorescence particularly applied to the field of self-adhesive articles.

Another objective is to provide visual message transmission device which makes use of the phenomenon of phosphorescence, applied or not to the field of self-adhesive articles, that is related to construction, fabrication or simple acquisition.

Another objective is to provide a visual message transmission device that makes use of the phenomenon of phosphorescence, applied or not to the field of self-adhesive articles, that is of low cost, particularly in the adhesive application, aiming at adjusting it to the uses it might be destined for, which demand low costs.

### BRIEF DESCRIPTION OF THE INVENTION

In view of the aspects and objectives mentioned above, the visual message transmission device, object of the present patent, was designed, comprehending, essentially: a light source, such as a light bulb; a transparent surface, such as a flashlight lens, which is placed in front of the light source and traversed by light; and a phosphorescent light-permeable pigment layer, applied to the transparent surface and that is activated, mainly from the back, by the light generated by the light source. The phosphorescent pigment layer can be painted or printed directly on the transparent medium associated to the light source, or it can preferably be printed on a transparent self-adhesive article which is glued on the transparent medium or printed on a paper base or similar material and transferred to the transparent medium. After pigment is properly positioned over transparent layer, and when the light source is on, it performs its illumination function and activates (charges) the phosphorescent layer, whose phosphorescence is emitted with the light, and when the light source is off, only the phosphorescence remains visible, displaying the message which it was designed to convey.

This translucid construction, with or without the self-adhesive application, is a new application of the phenomenon of phosphorescence, particularly useful for obtaining promotional or decorative or ludic or technical device.

The process of manufacturing the device, object of the present patent, in any of its versions, is of simple fabrication and construction, and it is of low cost, this way meeting another object of the invention.

### ILLUSTRATIVE EXAMPLES OF THE INVENTION

The accompanying drawings relate to the process for obtaining the visual message transmission device, object of the patent, in which:

FIG. 1 shows a design of the process scheme, essentially formed by light source, transparent layer and phosphorescent layer;

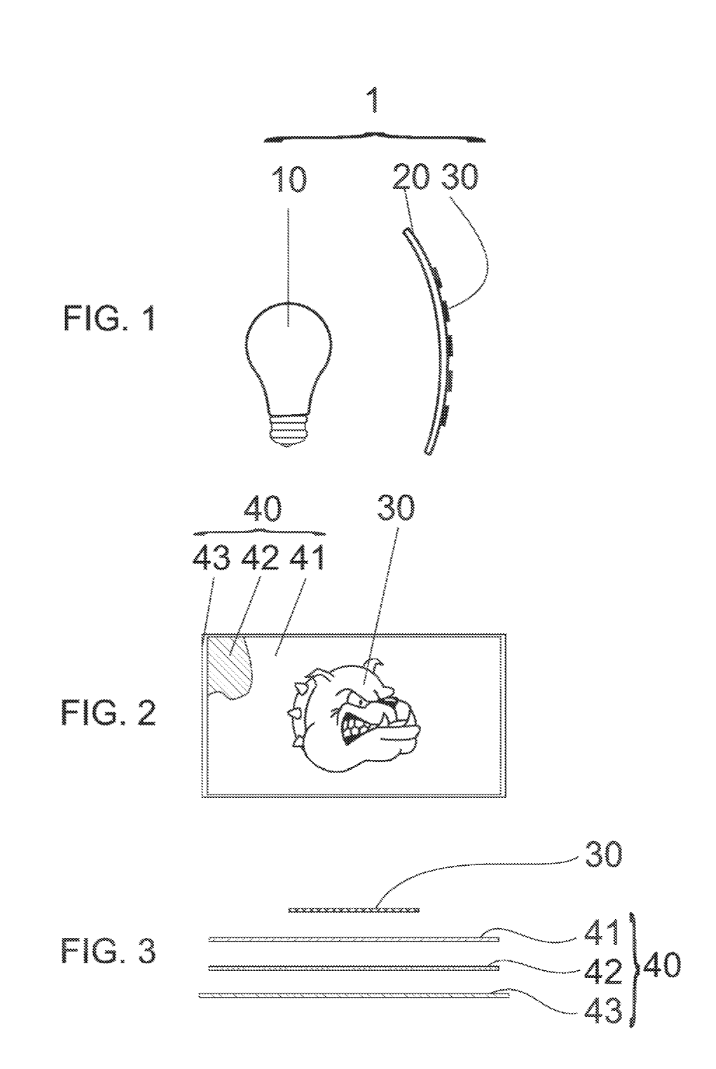

FIGS. 2 to 7 show the device in its self-adhesive version, isolated, in a sectional drawing, being applied and applied to the transparent surface and working under conditions of presence or absence of light from the light source, respectively; and

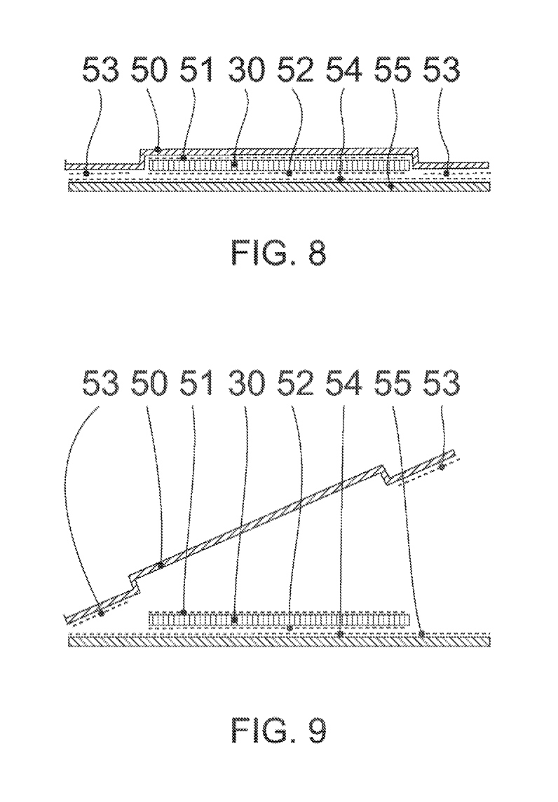

FIGS. 8 to 11 show another self-adhesive version of the device, isolated, in a sectional drawing, being applied and applied to the transparent surface, respectively.

### DETAILED DESCRIPTION BASED ON THE FIGURES

As the aforementioned figures show, device 1, object of the present patent, aims at transmitting or conveying visual messages of any type, such as: promotional or ludic or decorative or technical or others and it comprises essentially (FIG. 1): a light source 10; a transparent surface 20 placed in front of the light source 10 and traversed by light 11 generated by mentioned source; and a phosphorescent light-permeable pigment layer 30 applied to the transparent surface 20 and that is activated, mainly from the back, by light 11 generated by the light source 10 and that allows enough light to traverse so that the light source is able to perform its original specific illumination functions.

Thus, when the light source 10 from device 1 is on, that is, when it emits light 11 that illuminates the area in front of it, the phosphorescent layer 30 is illuminated, from the back, to the phenomenon of photoluminescence in which it is activated (charged) by light 11 and it simultaneously emits phosphorescence, allowing part of the light 11 to traverse, and this light is enough for the light source 10 to perform its specific and original illumination function. When the light source 10 is off, only the phosphorescence of the phosphorescent layer 30 remains visible and displays the image it constitutes, such as the silhouette of an object and/or animal and/or text or others, and the specific message it was designed to convey.

In detail, in a possibility of preferential realisation (FIGS. 2, 3), device 1 is of the indirect application type, self-adhesive, comprising, substantially: a phosphorescent layer 30 that configures the message to be displayed; and a self-adhesive transparent article 40 on which the phosphorescent layer is printed.

The self-adhesive article is comprised, essentially: by a main body of transparent film 41, a face of which has printed the phosphorescent layer 30; by layer of pressure-sensitive adhesive 42 adhered to the face of the main body of transparent film 41 opposed to the one that contains the phosphorescent layer 30 and which is adhered to the transparent layer 20; and by body of support and protection (liner) 43, on which the adhesive layer 42 is originally glued so as to be able to be detached.

The element of device 1, formed by the phosphorescent layer 30 and by the self-adhesive article 40, can be of the sheet type, comprising a liner sheet 43 which contains one or more units of the element formed by the layer 30 and the self-adhesive article 40 or comprising a liner tape 43 which contains a succession of units of element 30-40 and which is supplied on a reel and eventually can be segmented into sheets.

The phosphorescent layer 30 is a phosphorescent pigment that consists of rare earths or other minerals and phosphorescent chemicals in the market or that might be specially developed for the application. Such phosphorescent layer 30, besides being phosphorescent, must have some permeability to the light 11 from the light source 10, not to jeopardise its function. This permeability might be obtained by layer made from the translucid pigments characteristics or formed by a reticular made of parts with or without layer interleaved and regularly distributed, propitiating the effect of photoluminescence and permeability to the light 11.

The main body of transparent film 41 and the liner 43 are a plastic film of the type normally employed in self-adhesive articles, such as BOPP (polypropylene) and others.

The pressure-sensitive adhesive is also of type usually employed on self-adhesive articles.

The transparent surface 20 and the light source 10 are common illumination equipment, which provide artificial light, such as flashlight or lamp or flare or others.

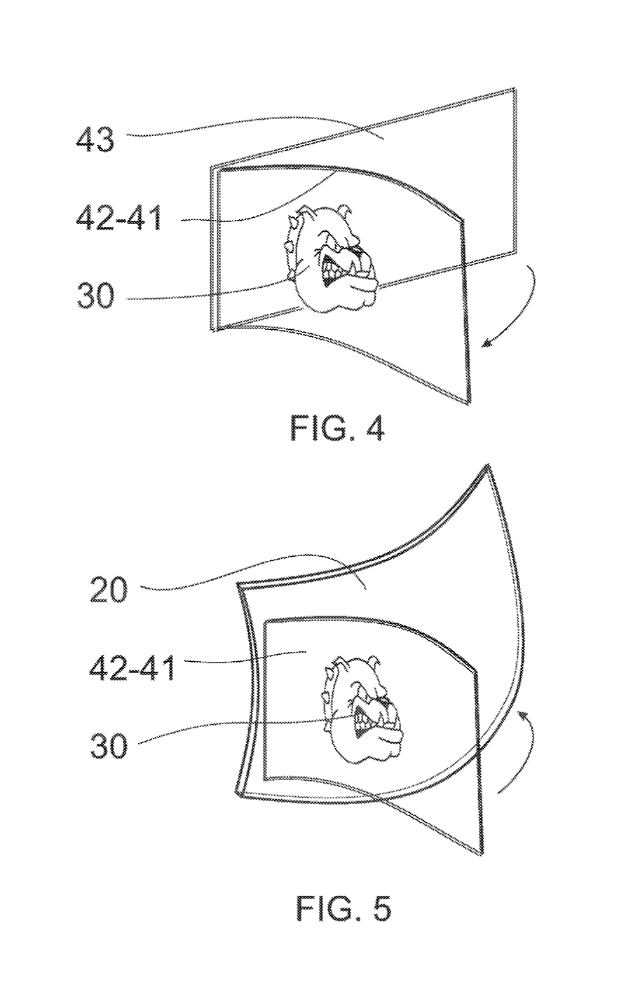

In this manner, in the application, the main body of self-adhesive transparent film 41-42, having the phosphorescent layer 30 printed on it, presents itself originally adhered to the liner 43. The user detaches (FIG. 4) the main body of transparent film 41-42 containing the phosphorescent layer 30 from the liner 43 e adheres its adhesive layer 42 to the transparent surface 20 disposed with the light source 10 (FIG. 5).

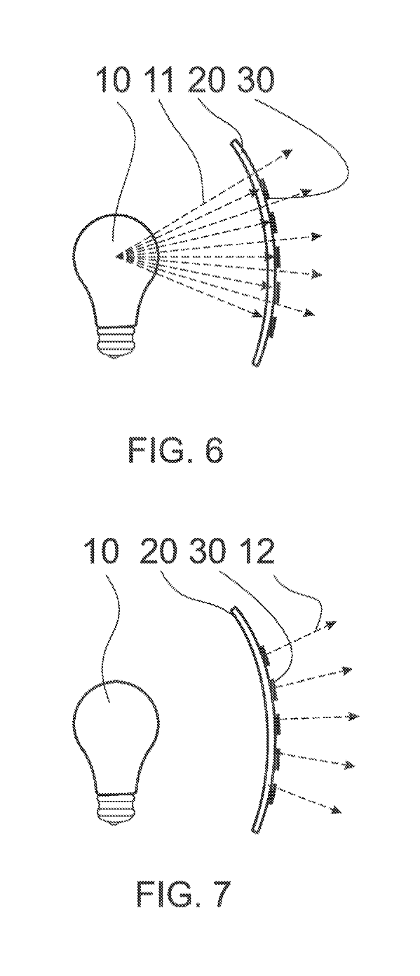

Therefore, when the light source 10 is on and generates light 11 (FIG. 6), the latter traverses the phosphorescent layer 30, performs the illumination function and activates (charges) the phosphorescent layer 30, whose phosphorescence is emitted alongside the light. When the light source 10 is turned off (FIG. 7), only the phosphorescence from the phosphorescent layer 30 remains visible, thus conveying, in the dark, in the absence of the light 11 from the light source 10, the message (images and/or texts) which are formed by the phosphorescent layer 30.

In another version of device 1, it is of the type of direct application by transference (transfer) and self-adhesive (FIG. 8) comprised, from top to bottom: by layer of coverage and protection of plastic film 50; by adhesive layer 51 placed over the phosphorescent layer 30, both placed under the layer of coverage and protection of plastic film 50; by adhesive layer 52 placed in the face which opposes the phosphorescent layer 30; by adhesive layers 53 placed in the internal face of the layer of protection of plastic film 51, not disposed over the phosphorescent layer 30; delivery layer 54 on which the phosphorescent layer 30 and, placed around it, the layer of coverage and protection of plastic film 50, are glued so as to be able to be detached; by body of support and protection (liner) 55, on which the delivery layer 54 is applied. In this case a sheet or tape device can also be projected. The delivery layer 54 is made from any material that can be used in self-adhesive articles, such as silicone or varnish.

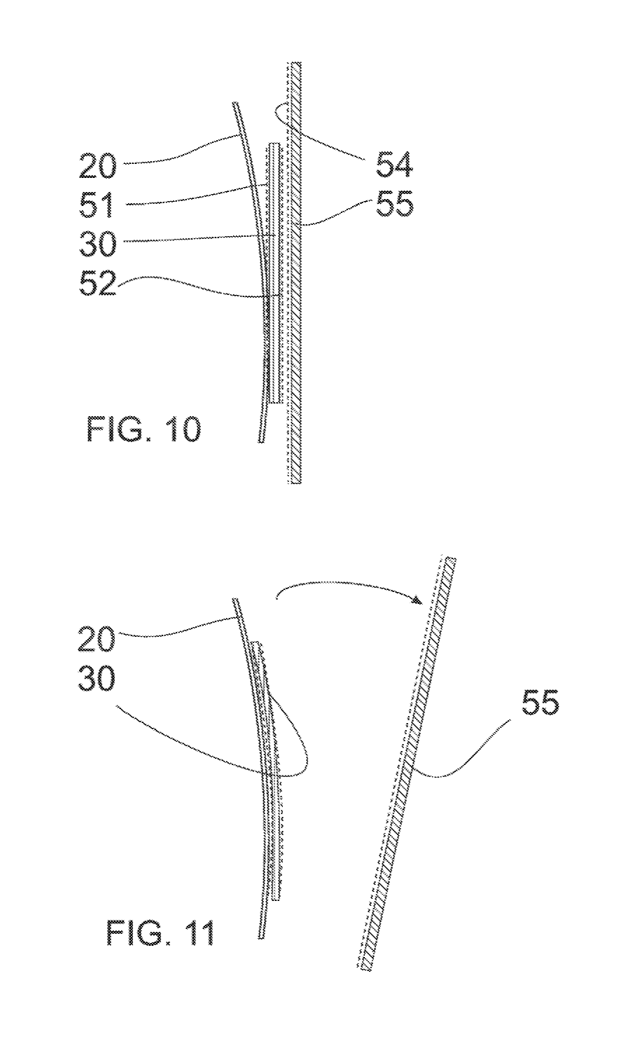

Therefore, in the application, firstly, the user detaches the layer of protection 50 from over the phosphorescent layer 30 and from the region of the liner 55 around it (FIG. 9). After that, the user glues the phosphorescent layer 30, still adhered to the liner 55 and through the adhesive layer 52, on the transparent surface 20 (FIG. 10). Lastly, the user detaches the liner 55 from over the phosphorescent layer 30 adhered to the transparent surface 20 (FIG. 11).

In the basic construction described above, it is pled that visual message transmission device 1, object of the present patent, may receive modifications in construction, sizing, materials, functional or ornamental configurations, not leaving the scope of protection.

In that regard, the device might be of direct application type, in which the phosphorescent layer 30 is painted or printed directly on the transparent surface 20.

The visual messages which are displayed might be of any type, such as promotional, decorative, ludic, or technical, or utility or sign messages, among others, formed by silhouettes and/or texts.

The light source 10 is preferably artificial and with the transparent surface 20 it may form any apparatus, such as a vehicular or motorcycle headlight or other lighting devices. The light source 10 can be the natural light and the transparent surface 20 can be, for example, a window or another an open airway providing light.

The device can be developed to have as sole purpose provide illumination on dark environments, rather than delivering a message or serving as warning sign.

### NOMENCLATURE

1—Visual message transmission device;

10—Light source;

20—Transparent surface;

11—Light generated by light source 10;

12—Phosphorescent light;

30—Phosphorescent pigment layer;

40—Transparent self-adhesive article;

41—Main body of transparent film;

42—Pressure-sensitive adhesive layer;

43—Body of support and protection (liner);

50—Layer of coverage and protection of plastic film;

51—Adhesive layer;

52—Adhesive layer;

53—Delivery layer;

54—Body of support and protection (liner).

1. VISUAL MESSAGE TRANSMISSION DEVICE for messages such as promotional or ludic or decorative or technical ones or signs, in the shape of the silhouette of any objects and/or texts, characterised: by light source (10); transparent surface (20) disposed in front of the light source (10) and traversed by light (11) generated by said source; and of layer (30) of phosphorescent and light-permeable pigment, which constitutes the visual message, applied to the transparent surface (20) and that, when the light source (10) is on, is activated (charged) mainly from behind and is traversed by light (11) generated by said source, and when the source is off, the phosphorescence (12) from the phosphorescent and light-permeable layer (30) remains visible and displays the message that it forms, in the shape of silhouettes of any objects and/or texts which form the visual message.

2. VISUAL MESSAGE TRANSMISSION DEVICE, according to claim 1, characterised by preferential construction of the self-adhesive type for indirect application, comprised: of phosphorescent light-permeable layer (30) which configures the message to be displayed; and of transparent self-adhesive article (40) on which the phosphorescent light-permeable layer (30) is printed and which is glued on the transparent surface (20).

3. VISUAL MESSAGE TRANSMISSION DEVICE, according to claim 2, characterised by self-adhesive article (40) comprised: of main body of transparent film (41), one face of which has the phosphorescent light-permeable layer (30) printed on; of layer of pressure-sensitive adhesive (42) adhered to the face of the main body of transparent film (41) opposed to the one that contains the phosphorescent light-permeable layer (30) and that is adhered to the transparent surface (20), and for body of support and protection (liner) (43), on which the adhesive layer is originally glued so as to be able to be detached.

4. VISUAL MESSAGE TRANSMISSION DEVICE, according to claim 1, characterised by phosphorescent light-permeable layer (30) composed by translucid phosphorescent pigment or reticular, composed by parts with and without layer interleaved and regularly distributed or distributed in a manner so to allow some of the light to pass.

5. VISUAL MESSAGE TRANSMISSION DEVICE, according to claim 1, characterised by construction of the self-adhesive type for direct application or by transference, consisting of self-adhesive composed: by plastic film coverage and protection layer (50); by adhesive layer (51) placed over the phosphorescent light-permeable layer (30), the latter placed under the plastic film coverage and protection layer (50); by adhesive layer (52) placed on the face which opposes the phosphorescent light-permeable layer (30); by adhesive layers (53), placed on the internal face of the plastic film protection layer (50) and not disposed over the phosphorescent light-permeable layer (30); delivery layer (54) on which the phosphorescent light-permeable layer (50) and, placed around it, the plastic film coverage and protection layer (50) are glued so as to be detached; by body of support acid protection (liner) (55), over which is placed the delivery layer (54).

6. VISUAL MESSAGE TRANSMISSION DEVICE, according to claim 1, characterised by construction for direct application, that consists on the phosphorescent light-permeable layer (30) painted or printed directly on to the transparent surface (20).

7. VISUAL MESSAGE TRANSMISSION DEVICE, according to claim 1, characterised by artificial light source (10) formed by light bulb or similar natural light source.

8. VISUAL MESSAGE TRANSMISSION DEVICE, according to claim 1, is characterised by transparent layer (20), comprised by lens or similar of Illumination device such as flashlight, lamp, flare or others and that is traversed by light (11) generated by artificial light source (10) or composed by component illumination of buildings, as well as natural light passages present at these constructions such as windowpane or similar, which is traversed by natural light.
